(19) United States
(12) Patent Application Publication
(10) Pub. No.: US 2009/0102602 A1
(43) Pub. Date: Apr. 23, 2009

(54) SYSTEM FOR THE RAPID DEPLOYMENT OF A CONCEALED OBJECT DETECTION SYSTEM

(76) Inventors: ROBERT PATRICK DALY, Orlando, FL (US); Willem H. Reinpoldt, III, Windermere, FL (US)

Correspondence Address: McKinney Law, LLC, 390 N. Orange Avenue, Suite 2300, Orlando, FL, 32801, US

(21) Appl. No.: 12/118,943

(22) Filed: May 12, 2008

Related U.S. Application Data
(60) Provisional application No. 60/917,436, filed on May 11, 2007.

(51) Int. Cl. G05B 19/00

(52) U.S. Cl. 340/5.1

(57) ABSTRACT

A system for the rapid deployment of a concealed object detection system (CODS) is disclosed. In a particular embodiment, a base having side walls about its periphery extending upwards are adapted to secure CODS camera and equipment within the base. The base includes a rolling means disposed along a rear edge so that the CODS equipment is easily transported to the desired location. A removable cover is adapted to slide over the CODS camera and equipment and abut the periphery of the base. Flexible planar material having blast mitigation properties is stored with the removable cover and is deployed to form an inspection area for the CODS camera. The system provides a standard platform for deployments of concealed object detection systems across extremely variable environments.

### I. CROSS REFERENCE TO RELATED APPLICATIONS

This application claims the benefit of U.S. Provisional Application No. 60/917,436 filed May 11, 2007. The disclosure of the provisional application is incorporated herein by reference.

### II. FIELD

The present invention relates in general to the field of concealed object detection, and in particular to a system for the rapid deployment of cameras such as millimeter wave cameras that are utilized in concealed object detection systems (CODS).

### III. DESCRIPTION OF RELATED ART

Security systems can be found at airports, train stations, arenas, construction sites, and other public, private, commercial and industrial facilities. In addition, security systems are used in harsh environments such as border control or field military operations. A passive millimeter wave camera is one type of CODS. The passive millimeter wave camera detects radiation that is given off by all objects. The technology works by contrasting the millimeter wave signature of the human body, which is warm and reflective, against that of a gun, knife or other contraband. Those objects appear in contrast because of the differences in temperature, hence, millimeter wave energy, between the human body and the inanimate objects.

The harsh and uncontrolled environments require that the prior art CODS must be adapted for each installation to provide the proper contrast between the environment and a subject so that the camera can detect concealed objects, which is expensive and time consuming. Further, personnel must be trained to operate the CODS for each different installation environment. Hence, a need exists in the art for a system for the rapid deployment of a CODS that simplifies training and ease of use by using a similar deployment for each CODS installation. A need also exists in the art for a system that eliminates the need to adapt the CODS camera(s) to an uncontrolled environment so that the system can provide rapid “on demand” deployment and that eliminates the need to custom engineer a deployment for each CODS application.

Another shortcoming is that the prior art CODS are dependent on existing utilities and on-site support, which is not always available for the CODS installation in a harsh environment. Accordingly, what is needed is a system for the rapid deployment of a concealed object detection system that eliminates the need for services to support the CODS camera such as air conditioning or other utilities and is not dependent on an external power source but has an independent power source.

Another need exists in the art for a system for the rapid deployment of a concealed object detection system that provides a stable, standard platform for deployments across extremely variable environments, resulting in lower installation costs and time, and simpler construction and support due to the standardized methodology.

Another need exists in the art for a system for the rapid deployment of a concealed object detection system that allows for a realization of manufacturing, engineering and procurement cost savings due to economies of scale.

Another need exists in the art for a system for the rapid deployment of a concealed object detection system that integrates camera, foot traffic containment and ambient energy mitigation.

Another need exists in the art for a system for the rapid deployment of a concealed object detection system that uses voice over internet protocol (VOIP) (or wired) intercom and wireless (or wired) Ethernet to connect to a remote monitoring station.

Another need exists in the art for a system for the rapid deployment of a concealed object detection system that simplifies the repair or replacement of a damaged deployment should it become necessary (e.g., due to an explosives detonation).

However, in view of the prior art at the time the present invention was made, it was not obvious to those of ordinary skill in the pertinent art how the identified needs could be fulfilled.

### IV. SUMMARY

In a particular embodiment, a system for the rapid deployment of a concealed object detection system is disclosed. The disclosed system is an approach for deploying a portable, self-contained, concealable, rapid deployment, concealed object detection system using pre-engineered and pre-manufactured components to effectively increase the deployment speed and control the deployment surroundings providing a known and successful environment in which a concealed object detection system camera can operate.

One particular advantage provided by embodiments of the system for the rapid deployment of a concealed object detection system is the highly portable, “on demand” design and construction. Deployment time is measured in minutes instead of hours or days. Another particular advantage provided by embodiments of the system is that the need to adapt the system's cameras to an uncontrolled environment is eliminated. In addition, the system for the rapid deployment of a concealed object detection system can operate as either an entry portal for weapons or contraband detection or as an exit portal for theft prevention or both.

Another particular advantage provided by embodiments of the system for the rapid deployment of a concealed object detection system is the possibility of covert deployment, either by its rapid deployment nature or by concealing the camera by virtue of its minimal footprint and deployment requirements. Accordingly, the deployment of the CODS equipment is completed without tools, simplifying and speeding deployment and re-deployment. Further, the CODS equipment can be powered using an independent on-board battery supply so that deployment of the CODS is possible away from standard utility service (e.g., in a field, forest, desert or hostile environment).

Another advantage provided by embodiments of the system is that the removable cover can store ancillary equipment like cables, batteries, mast poles, cross members, laptop computer, awning cables, ground stakes and/or fabric material for walls and awning. In addition, the removable cover of the system can be used as a podium or laptop computer stand.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a perspective view of a particular illustrative embodiment of a system for the rapid deployment of a concealed object detection system;

FIG. 2 is a perspective view of a particular illustrative embodiment of a rolling base of the system for the rapid deployment of a concealed object detection system;

FIG. 3 is a side view of a particular illustrative embodiment of a removable cover of the system for the rapid deployment of a concealed object detection system;

FIG. 4 is a perspective view of a particular illustrative embodiment of a millimeter wave camera of the system for the rapid deployment of a concealed object detection system;

FIG. 5 is a particular illustrative embodiment of a system for the rapid deployment of a concealed object detection system with a partial cut-away view of the removable cover; and

FIG. 6 is a perspective view of a particular illustrative embodiment of the inspection area defined by the flexible walls of a system for the rapid deployment of a concealed object detection system.

### VI. DETAILED DESCRIPTION

A system for the rapid deployment of a concealed object detection system is disclosed. The system provides effective control of deployment surroundings and provides a known and successful environment in which the CODS equipment (e.g., millimeter wave camera) can operate. Several components, techniques, technologies and methodologies including external millimeter wave energy mitigation, peripheral motion or clutter mitigation, test subject isolation, motion and flow control, threat containment, weather protection, decorative presentation, blast mitigation, and others may each be used separately, or in combination, with the system.

In a particular embodiment, the system includes a concealed object detection system that is adapatable for use with transportable screens or walls to mitigate ambient millimeter wave energy and simultaneously control the traffic flow and imaging field of view of the subjects passing in front of the camera(s). The system includes as least one CODS camera, such as a millimeter wave camera. In addition, the disclosed system may employ a passive millimeter wave illuminator louvered panel, such as that disclosed in U.S. patent application Ser. No. 60/917,414 filed May 11, 2007, the entire disclosure of which is incorporated herein by reference.

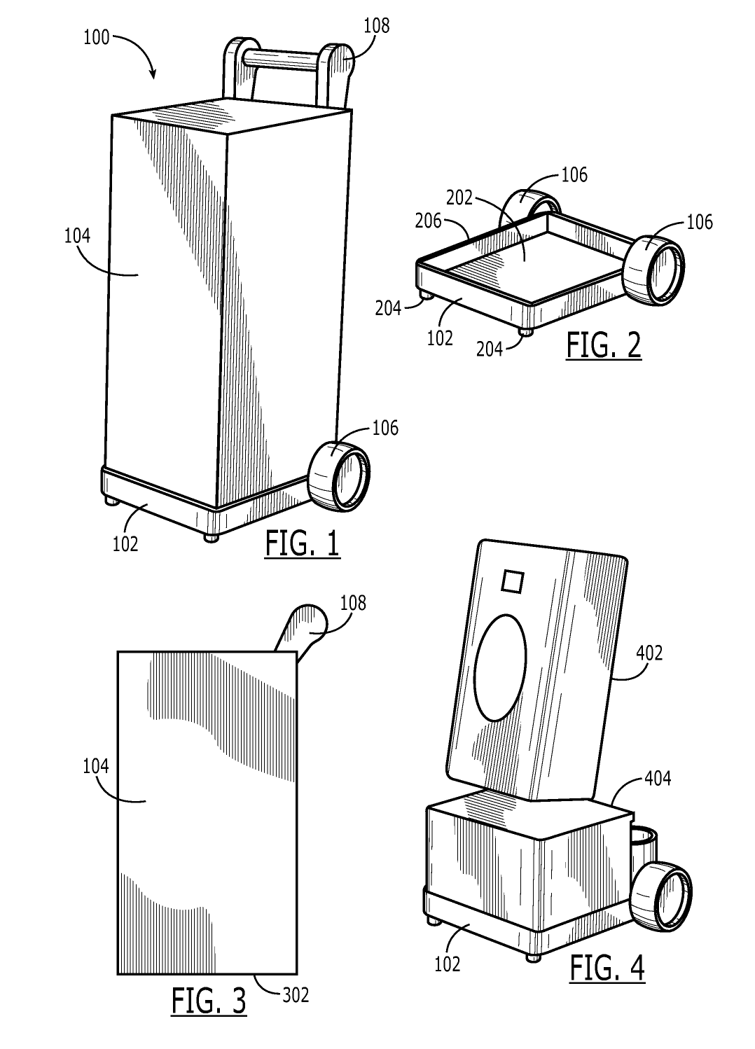

Referring to FIG. 1, a particular illustrative embodiment of a system for the rapid deployment of a concealed object detection system is disclosed. The disclosed system is generally designated 100. The disclosed system 100 is comprised of components, techniques, designs and construction that separately or together provide an advantageous, predictable, portable, controlled and managed environment within which the concealed object detection system operates optimally.

A base 102 is the structural foundation for the system and includes sidewalls about its periphery that extend upwards. A removable cover 104 has a similar cross sectional shape to the base 104 around its open end. The open end of the removable cover 104 is adapted to abut to the sidewalls of the base 102. A rolling means 106 is disposed about a rear edge of the base 102. The rolling means 106 includes wheels as shown in FIG. 1 but also includes rollers, spheres, and other similar configurations. The wheels 106 may be free-turning or electromechanically driven. A handle 108 is located about an upper rear edge of the cover 104 that can be used to push and direct the system 100 when delivering it to an installation. The handle 108 may also include controls for operating electromechanically driven wheels 106 to promote easy handling and increased portability. Accordingly, the system 100 provides an approach for deploying a concealed object detection system using a portable and highly mobile camera package in concert with portable components for ambient millimeter wave energy mitigation.

Referring now to FIG. 2, the base 102 may include two wheels 106 at the bottom rear corners of the base 102 and two leveling mounts 204 at the bottom front corners. The leveling mounts 204 may be fixed at a predetermined angle (or 0 degrees) or adjustable for a variable angle. In another implementation, the base 102 may include wheels 106 at all four bottom comers of the base 102 or alternately in a tricycle arrangement. The wheels 106 may also be recessed within base 102 to provide a smaller footprint. The sidewalls 206 extend upwards from base 102 about its periphery encompassing a planar surface 202 that supports the CODS equipment.

Referring now to FIG. 3, the cover 104 is removable via fasteners or latches near the bottom of the cover 104 for exposure of the CODS equipment camera, such as a Brijot Imaging System, Inc. millimeter wave camera. In this particular embodiment, the cover 104 is reusable in its removed state as a podium, stand or platform for subsequent use such as a laptop computer stand by a person standing upright. In another particular embodiment, the cover 104 may be hinged to expose the CODS equipment contained therein. Space within the cover 104 can be used for storage of cabling such as power cords, intercom wiring, Ethernet cables, etc.

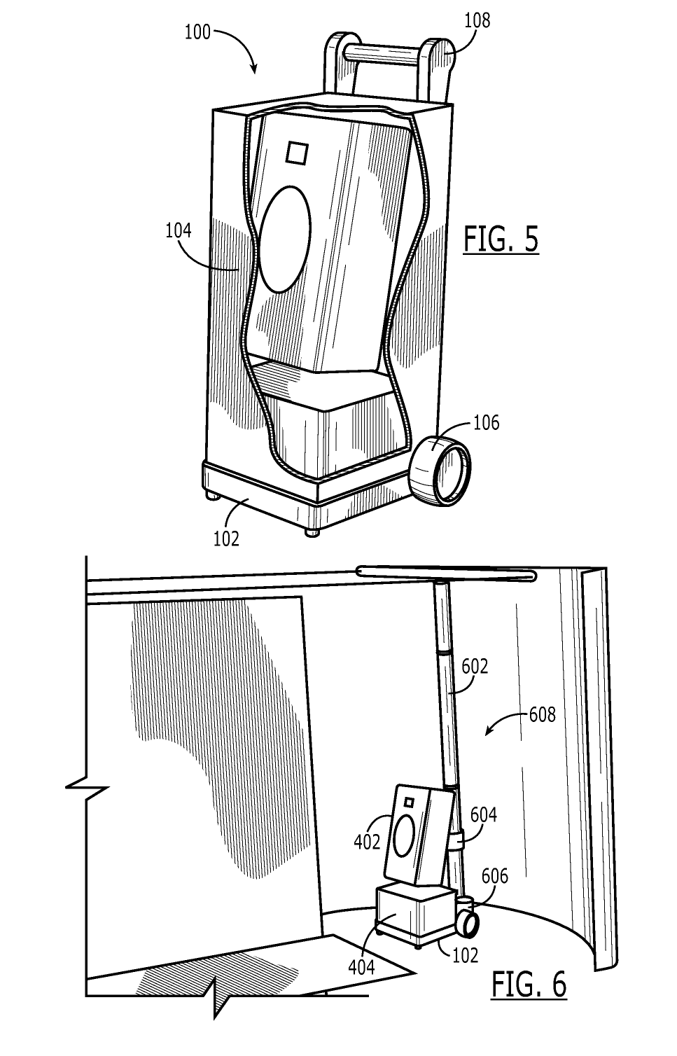

Referring now to FIG. 4, power for the CODS system is supplied by an independent power supply 404 such as an on-board battery using either disposable or rechargeable battery cells. A link for monitoring the CODS camera from remote monitoring stations (e.g., laptop) can be established by Ethernet cables or using a wireless Ethernet connection. The CODS camera is mounted above the power supply 404 and orientated for immediate operation. The removable cover 104 slides over the CODS equipment such as the camera 402 and independent power supply 404 as illustrated in FIG. 5. Space within the removable cover 104 such as behind the CODS camera can be used for storage of extendible member(s) or mast(s). A storage area is disposed between the camera 402 and independent power source 404 to store a laptop computer, for example. The laptop computer can be used as a remote monitoring station for the CODS camera 402.

Referring now to FIG. 6, a particular illustrative embodiment of a system for the rapid deployment of a concealed object detection system is disclosed. The camera 402 is positioned in proximity to and in series with the entry or exit of a parent structure or inspection area such that entry to or exit from the structure or area requires the subject to first transverse the inspection area in front of the camera 402. Performance of the CODS camera(s) 402 is improved by providing a stable, engineered, optimal operational environment. Defining the inspection area includes engineered solutions for flexible fabric, portable or louvered wall construction used for ambient millimeter wave energy mitigation, flow/traffic control, decorative presentation, blast mitigation, and reduction of peripheral visual/millimeter wave clutter. An extendible member 602 allows for the connection of optional fabric walls 608 and awning via a cross member as illustrated in FIG. 6 to define the inspection area. At least one open cylinder 604 disposed at the rear of the base 104 is adapted to secure the extendible member 602 therein in a vertical orientation. The fabric walls 608 and awning are supported between the camera(s) and optional backdrop via cable(s) or rope(s). In a particular illustrative embodiment, the fabric walls 608 and awning are attached to the cables in a shower curtain fashion. The fabric walls 608 are also adaptable to be fastened to the ground via ground stakes, weights, or similar attachments. In a particular embodiment, the fabric walls 608 are constructed of or coated with a material with blast mitigation properties such as Kevlar or Teflon.

The system 100 includes pre-engineered and pre-manufactured components to effectively implement object detection, to control the deployment surroundings, and to provide a controlled and successful environment in which the equipment can operate. The reliability of the CODS detection process is improved over the prior art by providing an engineered, millimeter wave-friendly operating environment.

In operation, the rapid deployment of the concealed object detection system begins with transporting the CODS system to the deployment site by virtue of its integrated portability features such as wheels and handles. Once on site, the CODS camera 402 is exposed from the removable cover 104 ia a lift-off protective cover, hinged access doors, lift off panels or other mechanism. The camera 402 can be leveled using adjustability on the wheels and/or leveling mounts of base 104. The camera 402 is connected to a power source or can be optionally powered by an independent power source such as an onboard battery.

To control the deployment environment, the flexible fabric 608 or otherwise portable walls and awnings are erected. Equipment to this effect (e.g., extendible members 602) may be stored inside the removable cover or inside a secondary container. The fabric walls 608 are secured using ground stakes, weights, or some other means to secure the fabric from excessive movement when susceptible to high winds. The securement means may be either integral to the fabric walls or separate.

The walls 608 contain access and egress points (gaps) to allow subjects of the camera inspection to enter and exit the inspection area. The configuration of the walls 608 form an inspection area or lane, thus containing and restricting the movement of subjects to be most advantageous of the camera's field of view, depth of field, optimum inspection distance and other properties.

Once deployed, a subject enters the inspection area, transverses the area at a normal walking pace, perhaps be required to stop and turn, and then continue out of the inspection area. The entry and exit points of the inspection area may be separate at opposite ends of the inspection area or may be the same. The system increases the security of a parent structure by providing CODS capabilities as well as locating the security checkpoint outside of the parent structure optionally designed with blast mitigation techniques and technologies (e.g., Kevlar fabric walls). Accordingly, the cost and complexity of deploying units in new environments is reduced.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system for the rapid deployment of a concealed object detection system (CODS), the system comprising:
a base having side walls about its periphery extending upwards and adapted to secure CODS equipment therein;
the base having a rolling means disposed along a rear edge; and
a removable cover having sidewalls about its periphery and extending downwards, wherein the cover is adapted to slide over the CODS equipment.

2. The system of claim 1, further comprising an independent power source to provide power to the CODS equipment.

3. The system of claim 1, wherein the removable cover further comprises a handle disposed along a rear edge.

4. The system of claim 2, wherein the independent power source is mounted to an upper surface of the base and the CODS equipment is mounted adjacent to the independent power source.

5. The system of claim 1, wherein the rolling means is recessed within the base.

6. The system of claim 1 wherein the CODS equipment is supported using an elongated member extending upwards from the base.

7. The system of claim 2 further comprising a storage compartment interposed between the CODS equipment and the independent power source.

8. The system of claim 1 wherein the CODS is a millimeter wave concealed object detection system having at least one millimeter wave camera.

9. The system of claim 1, wherein the removable cover providing an elevated working surface for a user standing upright.

10. A system for the rapid deployment of a concealed object detection system, the system comprising:
an enclosure for transporting CODS equipment wherein the enclosure is divided into a lower portion and an upper portion;
the upper portion having a chamber adapted to removably cover the CODS equipment; and
the lower portion having a planar surface for supporting the CODS equipment and a ridge about the periphery, wherein the lower portion further comprising an electromechanical rolling means to propel the enclosure.

11. The system of claim 10, further comprising a transceiver for establishing a wireless link between the CODS equipment and a remote monitoring station.

12. The system of claim 10 further comprising flexible planar material for establishing a deployment environment about the CODS equipment.

13. The system of claim 12, further comprising at least one extendable member to support the flexible planar material used for establishing the deployment environment.

14. The system of claim 10 wherein the CODS equipment is a millimeter wave concealed object detection system having at least one millimeter wave camera.

15. The system of claim 10, wherein the lower portion further comprising a leveling mount to adjust the angle of the CODS equipment.

16. The system of claim 10 further comprising a hinge interposed between the lower portion and the upper portion for exposing the CODS equipment.

17. The system of claim 10, further comprising battery cells to power the CODS equipment.

18. The system of claim 12, wherein the flexible planar material having blast mitigation properties.

19. The system of claim 10, wherein the enclosure further comprising a storage area for storing CODS accessories.

20. A system for the rapid deployment of a concealed object detection system (CODS), the system comprising:
a base having side walls about its periphery extending upwards and adapted to secure CODS equipment therein;
the base having a rolling means disposed along a rear edge;
a removable cover having sidewalls about its periphery and extending downwards, wherein the cover is adapted to slide over the CODS equipment;
the removable cover further comprising a handle disposed along a rear edge;
an independent power source to provide power to the CODS equipment;
a storage compartment interposed between the CODS equipment and the independent power source; and
a link between the CODS equipment and a remote monitoring station.
